(19) United States
(12) Patent Application Publication
(10) Pub. No.: US 2025/0389623 A1
(43) Pub. Date: Dec. 25, 2025

(54) SEAT DRIVEN PRESSURE INSPECTION SYSTEM

(71) Applicant: BRILS Co., Ltd., Incheon (KR)

(72) Inventor: Jin JEON, Incheon (KR)

(21) Appl. No.: 18/945,254

(22) Filed: Nov. 12, 2024

(30) Foreign Application Priority Data
Jun. 19, 2024 (KR) 10-2024-0079851

(51) Int. Cl. G01M 99/00

(52) U.S. Cl. CPC G01M 99/001

(57) ABSTRACT

A seat driven pressure inspection system includes a main frame installed on one side of an automobile production line for movement of a seat tray for installing the vehicle seat in which a first seat and a second seat are installed in close contact, a rail frame installed in a horizontal direction while facing the automobile production line in an upper end of the main frame, two sensing units installed to be slidably interlocked with the rail frame, moving rearward along the rail frame to approach the main frame when the vehicle seat moves, moving forward along the rail frame to face a measurement position of the vehicle seat when a driven pressure of the vehicle seat is measured, and sensing the driven pressure when the first seat and the second seat are folded or unfolded.

### CROSS REFERENCE TO RELATED APPLICATION

This application claims priority from Republic of Korea Patent Application No. 10-2024-0079851, filed on Jun. 19, 2024, which is hereby incorporated by reference in its entirety.

### BACKGROUND

### Field

The present disclosure relates to a seat driven pressure inspection system, and more specifically, relates to a seat driven pressure inspection system implemented to ensure an anti pinch function of a vehicle seat by determining whether the vehicle seat is qualified or disqualified for a load when third row seats of a vehicle are folded and unfolded.

### Description of Related Art

Beyond a concept of transportation means, vehicles recently have an added value as a space for relaxation, and accordingly, various functions for relaxation and convenience of passengers have been added to vehicle seats.

For example, the vehicle seats are equipped with automated functions such as a relaxing function of adjusting a seat angle with one touch so that the passengers adopt a zero-gravity neutral posture, and an easy access function of automatically sliding the vehicle seats to secure a space when the passengers get on and off the vehicle and adjusting a memory seat to suit a body type of a driver.

According to most of these automated functions, a posture of an electric seat is automatically adjusted with one touch by using a hotkey. However, when the seat is automatically adjusted, this operation may interfere with a body part of a rear seat passenger such as the a knee, an instep, and a shin, thereby causing a risk of injury when contact strength is high. Therefore, when the automated function is applied to the vehicle, an anti pinch verification system is required to prevent damage to the passenger due to interference with the seat.

However, seat testing machines in the related art are limited to testing strength and rigidity of the seat pursuant to laws and regulations, or mechanically testing noise, vibration, and harshness (NVH) and durability for failure determination and marketability checking. Consequently, there is a problem that no device for anti pinch verification of the seat having the automated function is available.

Meanwhile, the background technology described above is technical information owned by the inventor to derive the present disclosure or acquired in a process of deriving the present disclosure, and cannot necessarily be a publicly known technology disclosed to the general public prior to the application of the present disclosure.

(Patent Document 1) Korean Patent No. 10-2022-0024928 (Published on Mar. 3, 2022) and (Patent Document 2) Korean Patent No. 10-2022-0059290 (Published on May 10, 2022) are examples in the related art.

### SUMMARY

One aspect of the present disclosure provides a seat driven pressure inspection system implemented to check whether an anti pinch function is fulfilled without any problem by measuring a certain amount of a load after disposing a head in a vehicle seat when the vehicle seat folded or unfolded through servo control.

In addition, one aspect of the present disclosure provides a seat driven pressure inspection system implemented to identify a measurement location of an anti pinch function according to a vehicle type of a vehicle seat produced on a real-time basis, to verify the anti pinch function for each load, based on customer's standards, and to determine whether a product of the vehicle seat is operated before product shipment.

Technical aspects of the present disclosure are not limited to the above-described technical aspects, and other technical aspects not described herein will be clearly understood by those skilled in the art from the description below.

According to one embodiment of the present disclosure, there is provided a seat driven pressure inspection system including a main frame installed on one side of an automobile production line for movement of a seat tray for installing a vehicle seat in which a first seat and a second seat are installed in close contact, a rail frame installed in a horizontal direction while facing the automobile production line in an upper end of the main frame, two sensing units installed to be slidably interlocked with the rail frame, moving rearward along the rail frame to approach the main frame when the vehicle seat moves, moving forward along the rail frame to face a measurement position of the vehicle seat when a driven pressure of the vehicle seat is measured, and sensing the driven pressure when the first seat and the second seat are folded or unfolded, and a qualified product reading unit that reads whether the vehicle seat is qualified by using sensing information transmitted from the sensing unit.

In one embodiment, the rail frame may include a horizontal frame installed to be perpendicular to a movement direction of the vehicle seat while facing the automobile production line in the upper end of the main frame, two sliding holes formed to extend in a longitudinal direction along the horizontal frame so that an upper end of the sensing unit is seated and moved, two servo motors installed on an upper front side of the horizontal frame, and two ball screws installed by axial coupling to a drive shaft of the servo motor, disposed along an upper side of the sliding hole, installed to be interlocked with an upper end of the sensing unit by bolt coupling, and rotationally driven in a forward direction or in a reverse direction by the servo motor to move the sensing unit forward or rearward along the sliding hole.

In one embodiment, the sensing unit may include a horizontal slider disposed in the sliding hole, installed to be interlocked with the ball screw by bolt-nut coupling, and moving along the sliding hole as the ball screw is rotationally driven in the forward direction or in the reverse direction, a vertical body installed on a lower side of the horizontal slider, a mounting portion disposed in a front end of the vertical body, a driving unit that connects the vertical body and the mounting portion to each other, and a sensor unit installed in the mounting portion and sensing the driven pressure when the first seat and the second seat are folded or unfolded.

In one embodiment, the driving unit may include a raising and lowering cylinder installed in a front end of the vertical body and moving the mounting portion to be raised or lowered in an upward-downward direction while being driven to expand or contract in an up-down vertical direction, and a rotary cylinder that rotationally drives the mounting portion.

In one embodiment, the rotary cylinder may perpendicularly dispose the sensor unit to face downward so that the sensor unit senses the driven pressure in an unfolded state when the first seat and the second seat in a folded state are unfolded.

In one embodiment, the rotary cylinder may horizontally dispose the sensor unit to face forward so that the sensor unit senses the driven pressure in the folded state when the first seat and the second seat in the unfolded state are folded.

In one embodiment, the sensor unit may include a mounting plate installed to be connected to the mounting portion, rotated by the rotary cylinder, and perpendicularly or horizontally disposed, a sensing block installed to be slidably interlocked with a front end of the mounting plate, and receiving a pressure when the first seat and the second seat are folded or unfolded while an end exposed from the mounting plate is in close contact with the first seat and the second seat in a folded state or in a unfolded state, and a load cell installed in a rear end of the sensing block and transmitting measured sensing information to the qualified product reading unit after measuring intensity of the pressure transmitted to the sensing block.

In one embodiment, the raising and lowering cylinder may be driven to expand or contract in response to a sensing position with which the sensing block is in close contact when the first seat and the second seat are folded or unfolded, and raises or lowers the sensing block.

In one embodiment, the mounting plate may include a guide rails along one side and the other side of a front end on which the sensing block is seated.

In one embodiment, the sensing block may have a rail groove formed along one side and the other side of a bottom surface seated on the mounting plate to be slidably interlocked with the guide rail.

In one embodiment, the horizontal slider may include a connecting nut installed to be interlocked with the ball screw by bolt-nut coupling and moving along the ball screw as the ball screw is rotationally driven in the forward direction or in the reverse direction, and a nut support installed in an upper end of the vertical body, mounted on the connecting nut, and moving along the sliding hole as the connecting nut moves.

In one embodiment, the horizontal slider may further include two guide rails installed apart from each other on a downward facing surface of the horizontal frame with the sliding hole interposed therebetween, and two guides installed on one side and the other side of an upper end of the vertical body, installed to be interlocked with the guide rails, and sliding along the guide rails.

In one embodiment, the seat driven pressure inspection system according to another embodiment of the present disclosure may further include a seat cleaning unit installed in the automobile production line, and injecting compressed air to remove foreign substances adhering to the vehicle seat moved by the seat tray.

In one embodiment, the seat cleaning unit may include an installation housing formed in a polygonal frame shape so that the vehicle seat moved by the seat tray passes through the inside, and installed in the automobile production line, a rear end cleaning unit installed on rear end facing surface of the installation housing which faces a rear end of the vehicle seat, and cleaning a rear end of the vehicle seat, and a front end cleaning unit installed on an inward facing surface of a front end inclined surface of the installation housing which faces both a front end of a backrest and an upper side of a cushion which form the vehicle seat, and cleaning the front end of the backrest and the upper side of the cushion.

In one embodiment, the front end cleaning unit may include an inclined rail formed to extend along an inward surface of the front end inclined surface of the installation housing, a slider installed to be slidably interlocked with the inclined rail, a plurality of rail arms installed to be sequentially, mutually, and pivotally driven from the front end of the slider, forming a plurality of connecting joints, each of the connecting joints being pivotally driven to face the backrest and the cushion of the vehicle seat in parallel, and at least one cleaning module installed on each bottom surface of the plurality of rail arms facing the vehicle seat and cleaning the front end of the backrest or the upper side of the cushion.

In one embodiment, the cleaning module may include a rail groove formed to extend along a bottom surface of the rail arm, a module slider that slides along the rail groove to move to a compressed air injection position, a module body installed in a lower end of the module slider, a rotation guide groove formed to extend along an inner side of the module body while forming an opening portion on a lower side of the module body, and having a screw thread formed along an inner peripheral surface, a rotary injection unit formed in a cylindrical shape, installed to be rotatably interlocked with the screw thread of the rotation guide groove in an inner space of the rotation guide groove, and inserted into the rotation guide groove or exposed from the rotation guide groove as the rotary injection unit rotates in the forward direction or in the reverse direction, an actuator installed on an inner side of the rotation guide groove, supporting a rear end of the rotary injection unit, and driven to expand or contract to move the rotary injection unit forward or rearward, and an injection nozzle installed along a front end of the rotary injection unit and injecting compressed air for removing foreign substances.

In one embodiment, the rotary injection unit may include an injection unit body having a cylindrical shape and rotatably connected to a front end of the actuator, a hollow groove formed along an inner side of the injection unit body, a rotary column disposed to be rotatable along a center of an inner space of the hollow groove, a column drive motor perpendicularly installed on an upper side of the hollow groove, an upper end of the rotary column being installed in a drive shaft by shaft coupling so that the rotary column is rotationally driven in the forward direction or in the reverse direction, a plurality of “cross”-shaped rotors each having four rounded end portions, installed apart from each other at a regular interval along the rotary column by axial coupling, and rotating together as the rotary column rotates, four horizontal movement frames inserted by horizontally penetrating the injection unit body so that the four horizontal movement frames are perpendicular to each other on the same plane, each seated in close contact on the “cross”-shaped rotor in the hollow groove, and each simultaneously and horizontally moved by the “cross”-shaped rotor in a direction away from the rotary column or closer to the rotary column as the “cross”-shaped rotor rotates, a curved cover formed by roundly bending a flat plate, installed in each front end of the plurality of horizontal movement frames to cover the injection unit body, and forming a screw thread to be interlocked with a screw thread of an inward facing surface of the rotation guide groove along an outward facing surface, a cover support spring installed between the curved cover and the injection unit body to pull the curved cover in a direction of the injection unit body, a first magnetic body installed on an inner side of the curved cover and forming a magnetism, a second magnetic body formed in a circular ring shape along an inner side of the rotation guide groove which faces the first magnetic body and forming a magnetism, and a magnetic switch performing switch control on the magnetisms of the first magnetic body and the second magnetic body to an “N” pole or a “S” pole, and guiding the curved cover to be fastened to the inside of the rotation guide groove or guiding the curved cover to be separated from the inside of the rotation guide groove.

In one embodiment, the injection nozzle may include a nozzle installation groove formed to be recessed in a front end of the rotary injection unit, an elastic cover formed of an elastic material which is expandable or contractible, installed to cover a front end opening portion of the nozzle installation groove, expanded into a hemispherical shape by a hydraulic pressure as a fluid is supplied to the nozzle installation groove, and returning to a flat shape as the fluid is discharged from the nozzle installation groove, and a plurality of nozzles radially installed along the elastic cover to inject the compressed air, and injecting the compressed air in a direction perpendicular to the elastic cover when the elastic cover is flat, an injection direction of the compressed air being variable as the elastic cover expands.

According to one aspect of the present disclosure described above, it is possible to check whether an anti pinch function is properly fulfilled by measuring a certain amount of a load after disposing a head in a vehicle seat when the vehicle seat is folded or unfolded through servo control.

In addition, a measurement position of the anti pinch function may be identified according to a vehicle type of the vehicle seat produced on a real-time basis, the anti pinch function may be verified for each load, based on customer's standards, and it may be determined whether a product of the vehicle seat is operated before product shipment.

Advantageous effects of the present disclosure are not limited to advantageous effects described above, and may include various advantageous effects within the scope obvious to those skilled in the art from the contents described below.

### BRIEF DESCRIPTION OF THE DRAWING

FIG. 1 is a diagram showing a schematic configuration of a seat driven pressure inspection system according to one embodiment of the present disclosure.

FIGS. 2 and 3 are diagrams for describing a seat driven pressure inspection method used by the seat driven pressure inspection system according to one embodiment of the present disclosure in FIG. 1.

FIG. 4 is a diagram showing a rail frame in FIG. 1.

FIG. 5 is a diagram showing a sensing unit in FIG. 1.

FIG. 6 is a diagram showing a horizontal slider in FIG. 5.

FIG. 7 is a diagram showing a schematic configuration of a seat driven pressure inspection system according to another embodiment of the present disclosure.

FIGS. 8 and 9 are diagrams showing a cleaning module in FIG. 7.

FIGS. 10 and 11 are diagrams showing a rotary injection unit in FIG. 9.

FIG. 12 is a diagram showing an injection nozzle in FIG. 9.

### DETAILED DESCRIPTION

Detailed description of the present disclosure described below refers to the accompanying drawings that show specific embodiments for embodying the present disclosure. The embodiments will be described in sufficient detail to enable those skilled in the art to embody the present disclosure. It should be understood that various embodiments of the present disclosure are not necessarily mutually exclusive even though the embodiments are different from each other. For example, with regard to one embodiment, specific shapes, structures, and characteristics which are described herein may be implemented in other embodiments without departing from the concept and the scope of the present disclosure. In addition, it should be understood that positions or disposition of individual components within each disclosed embodiment may be changed without departing from the concept and the scope of the present disclosure. Accordingly, the detailed description of the present disclosure described below is not taken in a limiting sense, and the scope of the present disclosure is limited only by the appended claims, along with the full scope equivalent to the appended claims, if the scope of the present disclosure is properly described. Like reference numerals in the drawings designate the same or similar functions in various aspects.

Hereinafter, preferred embodiments of the present disclosure will be described in more detail with reference to the drawings.

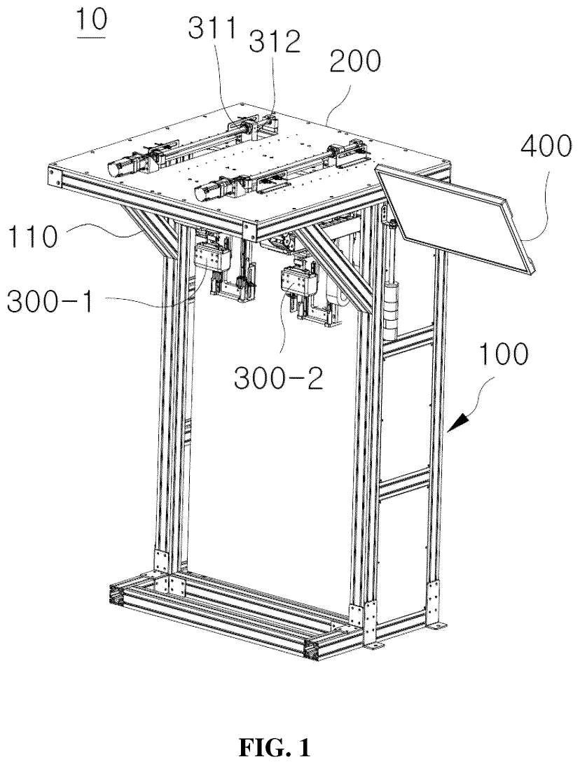

FIG. 1 is a diagram showing a schematic configuration of a seat driven pressure inspection system according to one embodiment of the present disclosure.

Referring to FIG. 1, a seat driven pressure inspection system (10) according to one embodiment of the present disclosure includes a main frame (100), a rail frame (200), two sensing units (300-1 and 300-2), and a qualified product reading unit (400).

An anti pinch function is a device for preventing unexpected accidents by detecting a load to check whether a passenger is on board when a vehicle seat is tilted, and is a very important element for passenger safety.

The present disclosure provides an anti pinch test device manufactured to determine whether the vehicle seat is normally operated.

The main frame (100) is installed on one side of an automobile production line (L) for movement of a seat tray for installing a vehicle seat(S) in which a first seat (S1) and a second seat (S2) are installed in close contact.

In one embodiment, the main frame (100) includes a high-strength profile to enhance structural stability of the device. An outer cover is formed of the same material to protect electrical components disposed inside a system control box from dust or foreign substances generated from an outside, and a reinforcing bar (110) is provided between the main frame (100) and the rail frame (200) to minimize shaking of the rail frame (200) installed to protrude.

The rail frame (200) is installed in a horizontal direction while facing the automobile production line (L) in an upper end of the main frame (100).

The two sensing units (300-1 and 300-2) are installed to be slidably interlocked with the rail frame (200), move rearward along the rail frame (200) to approach the main frame (100) when the vehicle seat(S) moves, move forward along the rail frame (200) to face a measurement position of the vehicle seat(S) when a driven pressure of the vehicle seat(S) is measured, and sense the driven pressure when the first seat (S1) and the second seat (S2) are folded or unfolded.

In one embodiment, the two sensing units (300-1 and 300-2) may move in response to the measurement position of the anti pinch function according to a type of the vehicle seat produced on a real-time basis.

The qualified product reading unit (400) uses sensing information transmitted from the sensing unit (300) to read whether the vehicle seat(S) is qualified.

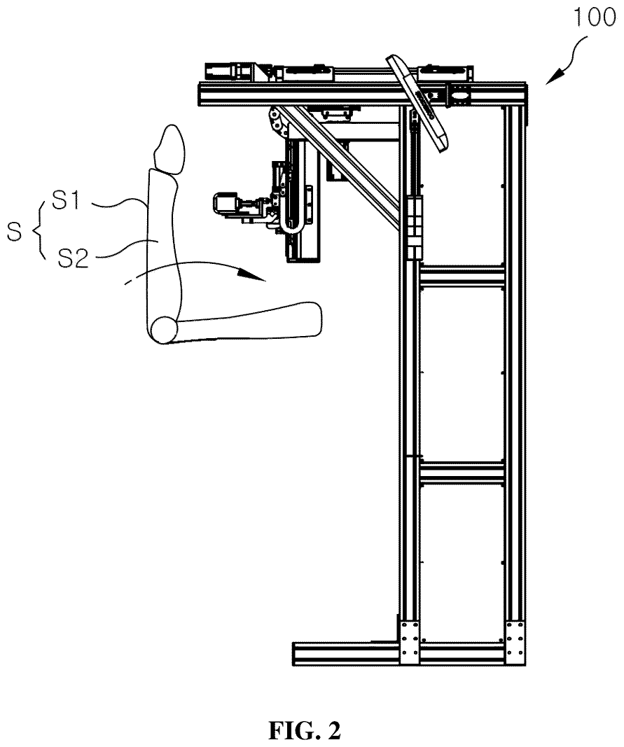

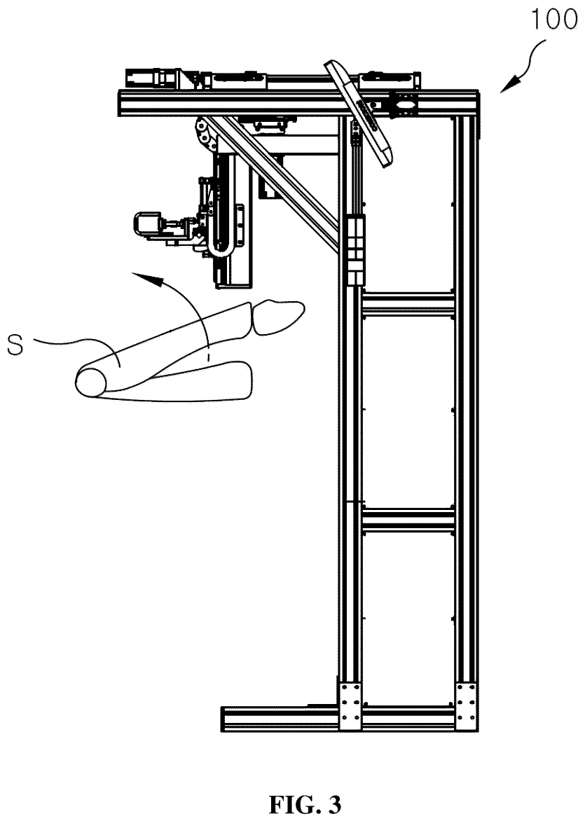

The seat driven pressure inspection system (10) according to one embodiment of the present disclosure having the above-described configuration may use one system to sense the driven pressure not only in a case of the first seat (S1) and the second seat (S2) which are folded from an unfolded state as illustrated in FIG. 2, but also in a case of the first seat (S1) and the second seat (S2) which are unfolded from a folded state as illustrated in FIG. 3.

The seat driven pressure inspection system (10) according to one embodiment of the present disclosure having the above-described configuration may check whether the anti-pinch function is fulfilled without any problem by measuring a certain amount of a load after disposing a head in the vehicle seat when the vehicle seat is folded or unfolded through servo control.

In addition, the measurement position of the anti-pinch function may be identified according to a vehicle type of the vehicle seat produced on a real-time basis, the anti-pinch function may be verified for each load, based on customer's standards, and it may be determined whether a product of the vehicle seat is operated before product shipment.

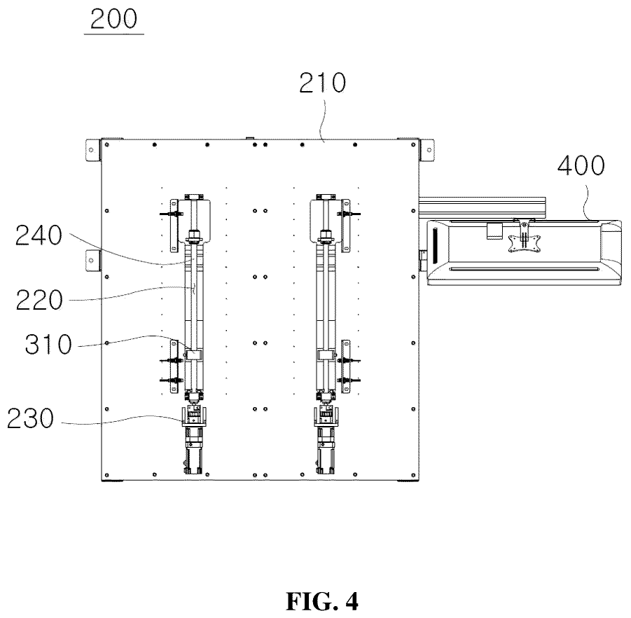

FIG. 4 is a diagram showing the rail frame in FIG. 1.

Referring to FIG. 4, the rail frame (200) includes a horizontal frame (210), two sliding holes (220), two servo motors (230), and two ball screws (240).

The horizontal frame (210) is installed to be perpendicular to a movement direction of the vehicle seat(S) while facing the automobile production line (L) in an upper end of the main frame (100), and is provided with configurations such as the two sliding holes (220), the two servo motors (230), and the two ball screws (240).

The two sliding holes (220) are formed to extend in a longitudinal direction along the horizontal frame (210) so that an upper end of the sensing unit (300) may be seated and moved.

The two servo motors (230) are installed on an upper end front side of the horizontal frame (210) to rotationally drive the ball screw (240) in a forward direction or in a reverse direction.

The two ball screws (240) are installed in a drive shaft of the servo motor (230) by axial coupling, are disposed along an upper side of the sliding hole, are installed to be interlocked with an upper end of the sensing unit (300) by bolt coupling, and are rotationally driven in the forward direction or in the reverse direction by the servo motor (230) to move the sensing unit (300) forward or rearward along the sliding hole (220).

The rail frame (200) having the above-described configuration may be installed while facing the automobile production line (L) so that the sensing unit (300) is stably seated, and may precisely slide the sensing unit (300) in response to a sensing position of the sensing unit (300).

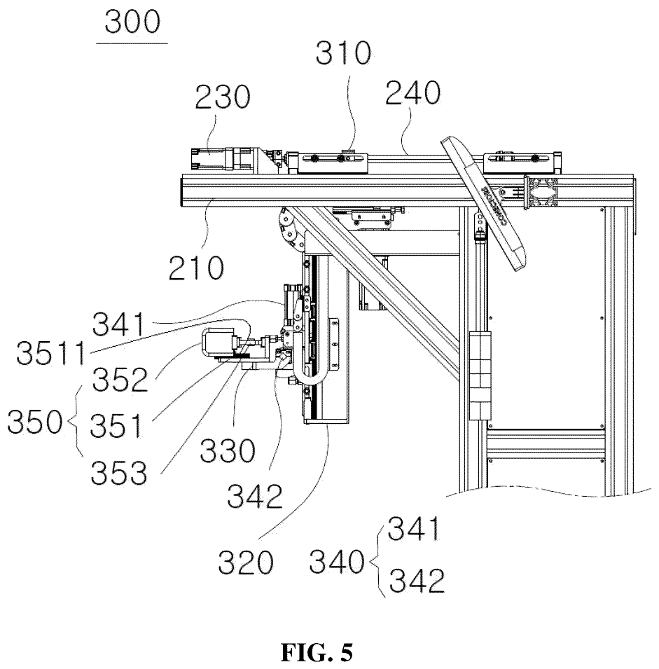

FIG. 5 is a diagram showing the sensing unit in FIG. 1.

Referring to FIG. 5, the sensing unit (300) includes a horizontal slider (310), a vertical body (320), a mounting portion (330), a driving unit (340), and a sensor unit (350).

The horizontal slider (310) is disposed in the sliding hole (220), and is installed to be interlocked with the ball screw (240) by bolt-nut coupling. As the ball screw (240) is rotationally driven in the forward direction or in the reverse direction, the horizontal slider (310) moves along the sliding hole (220), and moves the vertical body (320).

The vertical body (320) is installed on a lower side of the horizontal slider (310) to install the mounting portion (330).

The mounting portion (330) is disposed in a front end of the vertical body (320).

The driving unit (340) connects the vertical body (320) and the mounting portion (330) to each other.

In one embodiment, the driving unit (340) may include a raising and lowering cylinder (341) and a rotary cylinder (342).

The raising and lowering cylinder (341) is installed in a front end of the vertical body (320), and moves the mounting portion (330) to be raised or lowered in an upward-downward direction while being driven to expand or contract in an up-down vertical direction, and moves the sensor unit (350) to the sensing position of the sensor unit (350).

In one embodiment, the raising and lowering cylinder (341) may be driven to expand or contract in response to a sensing position with which the sensing block (352) is in close contact when the first seat (S1) and the second seat (S2) are folded or unfolded, and may move the sensing block (352) to be raised or lowered.

The rotary cylinder (342) rotationally drives the mounting portion (330) so that the sensor unit (350) is tilted to the sensing position of the sensor unit (350).

In one embodiment, as shown in FIG. 3, the rotary cylinder (342) may perpendicularly dispose the sensor unit (350) to face downward so that the sensor unit (350) may sense the driven pressure in an unfolded state when the first seat (S1) and the second seat (S2) in a folded state are unfolded.

In one embodiment, as shown in FIG. 2, the rotary cylinder (342) may horizontally dispose the sensor unit (350) to face forward so that the sensor unit (350) may sense the driven pressure in the folded state when the first seat (S1) and the second seat (S2) in the unfolded state are folded.

The sensor unit (350) is installed in the mounting portion (330), and senses the driven pressure when the first seat (S1) and the second seat (S2) are folded or unfolded.

In one embodiment, the sensor unit (350) may include a mounting plate (351), a sensing block (352) and a load cell (353).

The mounting plate (351) is installed to be connected to the mounting portion (330), is rotated by the rotary cylinder (342), and is disposed perpendicularly or horizontally.

In one embodiment, the mounting plate (351) may include a guide rail (3511) along one side and the other side of a front end on which the sensing block (352) is seated.

The sensing block (352) is installed to be slidably interlocked with a front end of the mounting plate (351). An end portion exposed from the mounting plate (351) comes into close contact with the first seat (S1) and the second seat (S2) which are folded or unfolded. The sensing block (352) receives the pressure generated when the first seat (S1) and the second seat (S2) are folded or unfolded, and transmits the pressure to the load cell (353).

In one embodiment, the sensing block (352) may have a rail groove (not shown in the drawing for convenience of description formed along one side and the other side of a bottom surface seated on the mounting plate (351) to be slidably interlocked with the guide rail (3511).

The load cell (353) is installed in a rear end of the sensing block (352), measures intensity of the pressure transmitted to the sensing block (352), and thereafter, transmits measured sensing information to the qualified product reading unit (400).

The sensing unit (300) having the above-described configuration not only may move the sensor unit (350) in the upward-downward direction in response to the sensing position of the sensor unit (350), but also may variably tilt a sensing angle of the sensor unit (350).

That is, when sensing the pressure of the first seat (S1) and the second seat (S2) which are folded from the unfolded state as illustrated in FIG. 2, the sensing unit (300) having the above-described configuration lifts the sensor unit (350) in a state where the sensing unit (300) moves forward along the rail frame (200). Thereafter, the sensing unit (300) drives and tilts the sensor unit (350) forward so that the sensor unit (350) faces the first seat (S1) and the second seat (S2). When sensing the pressure of the first seat (S1) and the second seat (S2) which are unfolded from the folded state as illustrated in FIG. 3, in a state where the sensing unit (300) moves rearward close to the main frame (100) along the rail frame (200), the sensing unit (300) drives and tilts the sensor unit (350) downward so that the sensor unit (350) faces the first seat (S1) and the second seat (S2). In this manner, precise measurement may be performed in response to positions of the first seat (S1) and the second seat (S2).

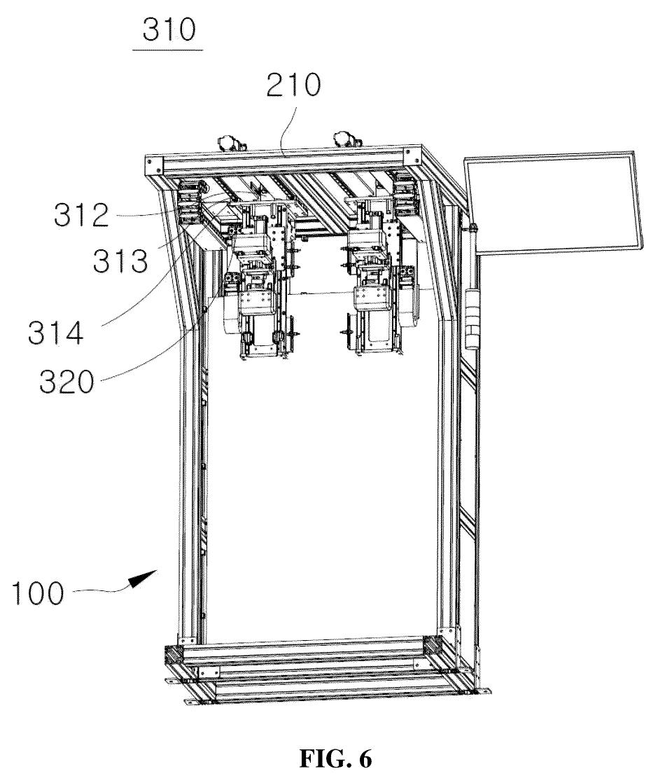

FIG. 6 is a diagram showing the horizontal slider in FIG. 5.

Referring to FIG. 6, the horizontal slider (310) includes a connecting nut (311) and a nut support (312).

The connecting nut (311) is installed to be interlocked with the ball screw (240) by bolt-nut coupling as shown in FIG. 1, and moves the nut support (312) while moving along the ball screw (240) as the ball screw (240) is rotationally driven in the forward direction or in the reverse direction.

The nut support (312) is installed in an upper end of the vertical body (320), is mounted on the connecting nut (311), and moves along the sliding hole (220) as the connecting nut (311) moves.

The horizontal slider (310) having the above-described configuration may further include two guide rails (313) and two guides (314).

The two guide rails (313) are installed apart on a downward facing surface of the horizontal frame (210) with the sliding hole (220) interposed therebetween.

The two guides (314) are installed on one side and the other side of an upper end of the vertical body (320), and are installed to be interlocked with the guide rail (313) to slide along the guide rail (313).

The horizontal slider (310) having the above-described configuration may precisely move in a forward-rearward direction of the sensor unit (350) performing the sensing.

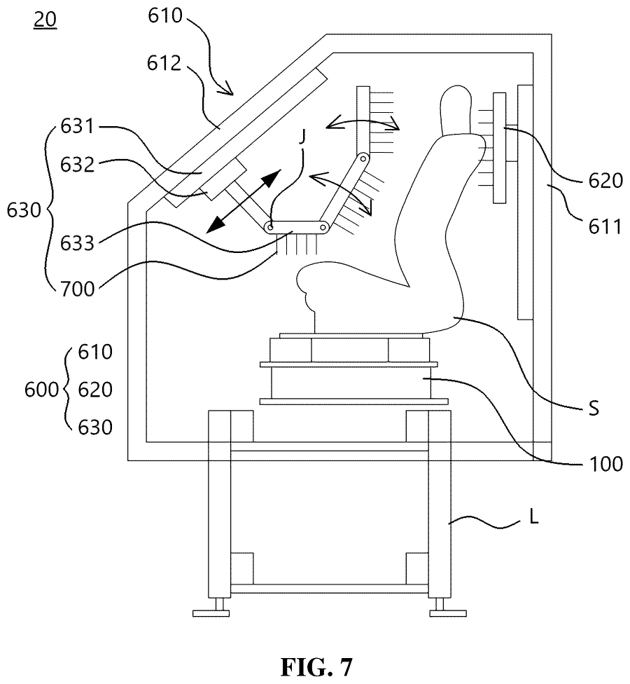

FIG. 7 is a diagram showing a schematic configuration of a seat driven pressure inspection system according to another embodiment of the present disclosure.

Referring to FIG. 7, a seat driven pressure inspection system (20) according to another embodiment of the present disclosure includes a seat tray (100), a main frame (200), a forward movement driving unit (300), a first connector (400), and a seat cleaning unit (600).

Here, the seat tray (100), the main frame (200), the forward movement driving unit (300), and the first connector (400) are the same as the components in FIG. 1, and thus, description thereof will omitted to avoid repeated description.

At least one seat cleaning unit (600) is installed along the automobile production line (L), and injects compressed air to remove foreign substances such as dust adhering to the vehicle seat(S) moved by the seat tray (100).

In one embodiment, the seat cleaning unit (600) may include an installation housing (610), a rear end cleaning unit (620), and a front end cleaning unit (630).

The installation housing (610) is formed in a polygonal frame shape so that the vehicle seat(S) moved by the seat tray (100) passes through the inside, and installed in the automobile production line (L), configured in a polygonal frame shape so that the vehicle seat(S) moving by the seat tray (100) can pass through the inside, and is installed in an automobile production line (L), and is provided with configurations such as the rear end cleaning unit (620) and the front end cleaning unit (630).

The rear end cleaning unit (620) is installed on an inward facing surface of a vertical surface (611) formed in a rear end of the installation housing (610) facing a rear end of the vehicle seat(S), and cleans foreign substances such as dust by injecting the compressed air in a rear end direction of the vehicle seat(S).

The front end cleaning unit (630) is installed on an inward facing surface of a front end inclined surface (611) of the installation housing (610) facing both a front end of a backrest and an upper side of a cushion which form the vehicle seat(S), and cleans foreign substances such as dust by injecting the compressed air in a direction of the front end of the backrest and the upper side of the cushion.

In one embodiment, the front end cleaning unit (630) may include an inclined rail (631), a slider (632), a rail arm (633), and a cleaning module (700).

Here, the rear end cleaning unit (620) has the same configuration as the front end cleaning unit (630) described later, and the inclined rail (631), the slider (632), rail arm (633), and the cleaning module (700) of the front end cleaning unit (630) may be applied in the same manner. Therefore, description thereof will be omitted to avoid repeated description.

The inclined rail (631) is formed to extend along the inward facing surface of the front end inclined surface (612) of the installation housing (610) so that the slider (632) may be slidably interlocked with the inclined rail (631).

The slider (632) is installed to be slidably interlocked with the inclined rail (631), and moves the rail arm (633) in response to a cleaning position.

A plurality of the rail arms (633) are installed to be sequentially, mutually, and pivotally driven from the front end of the slider (632), forms a plurality of connecting joints (J), and each connecting joint is pivotally driven to face both the backrest and the cushion of the vehicle seat(S) in parallel.

At least one cleaning module (700) is installed on a bottom surface of each of the plurality of rail arms (633) facing the vehicle seat(S), and performs cleaning by injecting the compressed air in the front end of the backrest or the upper side of the cushion to remove foreign substances.

The seat driven pressure inspection system (20) according to another embodiment of the present disclosure having the above-described configuration may improve manufacturing quality of the vehicle seat(S) without stopping a manufacturing process by removing the foreign substances such as dust adhering to the vehicle seat(S) without being stopped during the movement of the vehicle seat(S).

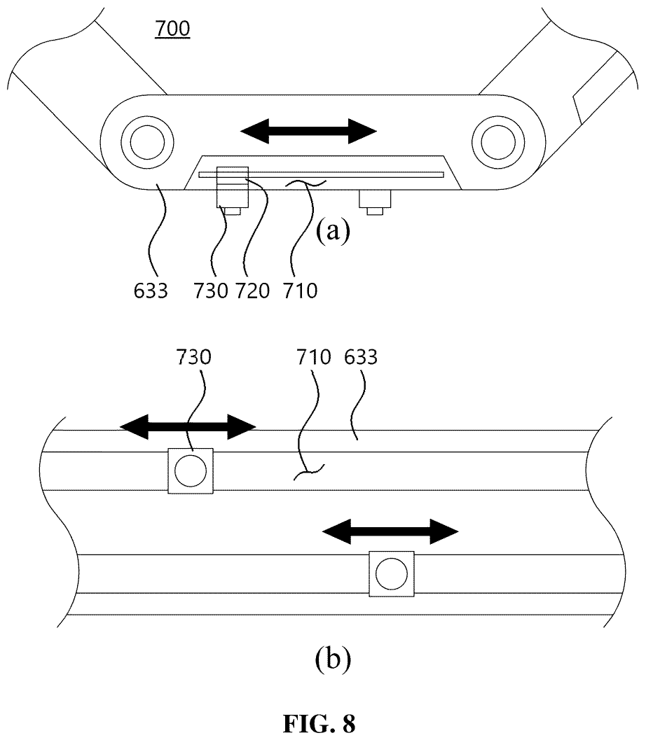

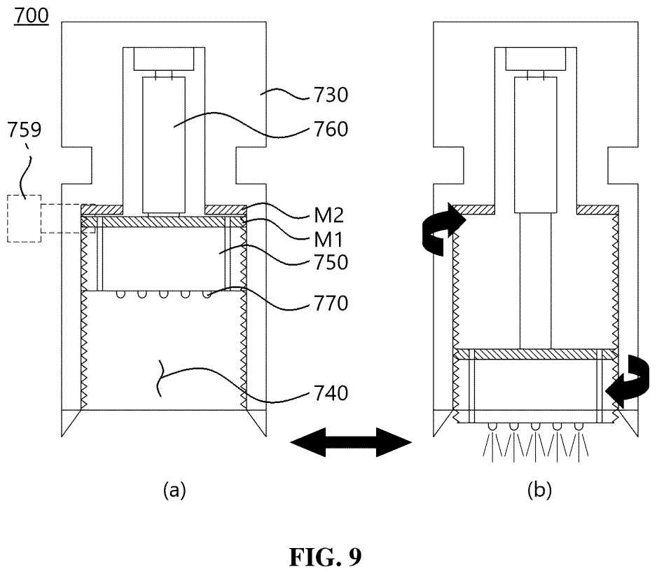

FIGS. 8 and 9 are diagrams showing the cleaning module in FIG. 7.

Referring to FIGS. 8 and 9, the cleaning module (700) includes a rail groove (710), a module slider (720), a module body (730), a rotation guide groove (740), a rotary injection unit (750), an actuator (760), and an injection nozzle (770).

The rail groove (710) is formed to extend along the bottom surface of the rail arm (633) so that the module slider (720) may be slidably interlocked with the rail groove (710).

The module slider (720) slides along the rail groove (710) to a compressed air injection position to move the module body (730).

The module body (730) is installed in a lower end of the module slider (720), and is provided with configurations such as the rotation guide groove (740), the rotary injection unit (750), the actuator (760), and the injection nozzle (770).

The rotation guide groove (740) is formed to extend along an inner side of the module body (730) while forming an opening portion on a lower side of the module body (730) so that the rotary injection unit (750) may be interlocked, inserted, or exposed, and forms a screw thread formed along an inner surface.

The rotary injection unit (750) is formed in a cylindrical shape, is installed to be interlocked with the screw thread of the rotation guide groove (740) to be rotatable on an inner space of the rotation guide groove (740), and is inserted into the rotation guide groove (740) or exposed from the rotation guide groove (740) as the rotary injection unit (750) rotates in the forward direction or in the reverse direction.

In one embodiment, the rotary injection unit (750) may move along the rotation guide groove (740) while rotating as the actuator (760) expands or contracts when the rotary injection unit (750) is seated in close contact on an inner peripheral surface of the rotation guide groove (740) as a curved cover (757) described later moves away from the injection unit body (751), and when the rotary injection unit (750) is separated from the inner peripheral surface of the rotation guide groove (740) as the curved cover (757) comes into close contact with the injection unit body (751), the rotary injection unit (750) may move along the rotation guide groove (740) in a linear direction without rotating as the actuator (760) expands or contracts.

In one embodiment, the rotary injection unit (750) may reduce a cleaning area using the compressed air by reducing an injection angle of the compressed air injected from the cleaning module (700) when the rotary injection unit (750) is inserted the rail groove (710) as shown in (a) of FIG. 9, and may increase the cleaning area using the compressed air by increasing the injection angle of the compressed air injected from the cleaning module (700) when the rotary injection unit (750) moves forward to the front end of the rail groove (710) as shown in (b) of FIG. 9.

The actuator (760) is installed inside the rotation guide groove (740) to support the rear end of the rotary injection unit (750), and is driven to expand or contract to move the rotary injection unit (750) forward or backward.

The injection nozzle (770) is installed along the front end of the rotary injection unit (750), and removes foreign substances by injecting the compressed air supplied from an externally installed compressed air supply device (not shown in the drawing for convenience of description).

The cleaning module (700) having the above-described configuration may improve efficiency of removing the foreign substances by guiding the rotation of the compressed air injected from the injection nozzle (770) or variably changing the injection angle of the compressed air by rotationally driving the module body (730).

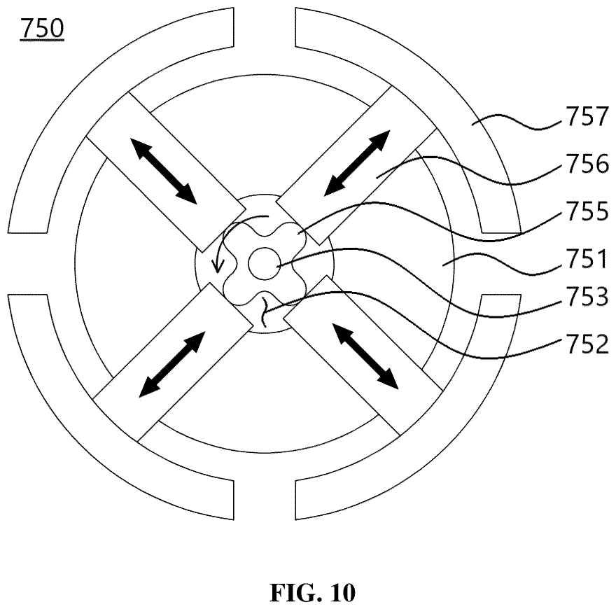

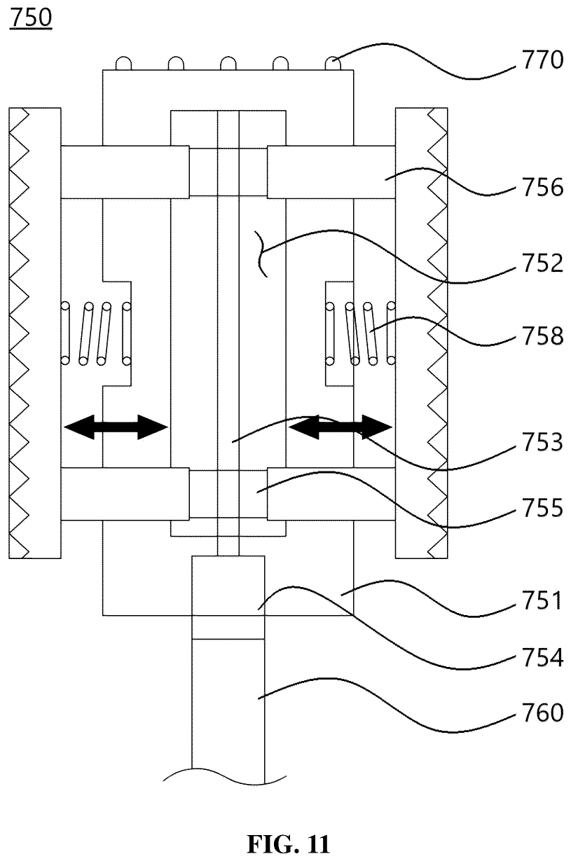

FIGS. 10 and 11 are diagrams showing the rotary injection unit in FIG. 9.

Referring to FIGS. 10 and 11, the rotary injection unit (750) includes an injection unit body (751), a hollow groove (752), a rotary column (753), a column drive motor (754), a “cross”-shaped rotor (755), a horizontal movement frame (756), a curved cover (757), and a cover support spring (758).

The injection nozzle (770) is installed along the front end exposed from the rotation guide groove (740), the injection unit body (751) is formed in a cylindrical shape, and is rotatably connected to the front end of the actuator (760). The injection unit body (751) is provided with configurations such as the hollow groove (752), the rotary column (753), the column drive motor (754), the “cross”-shaped rotor (755), the horizontal movement frame (756), the curved cover (757), a first magnetic body (M1), a second magnetic body (M2), the cover support spring (758), and a magnetic switch (759).

The hollow groove (752) is formed to be hollow along the inner side of the injection unit body (751) while forming a sufficient space in which the rotary column (753) is disposed and the “cross”-shaped rotor (755) is disposed to rotate.

The rotary column (753) is disposed to be rotatable around the center of the inner space of the hollow groove (752), and is rotationally driven by the column drive motor (754) to rotate the “cross”-shaped rotor (755) together.

The column drive motor (754) is installed perpendicularly to the upper side of the hollow groove (752), and the upper end of the rotary column (753) is installed to the drive shaft by axial coupling. In this manner, the rotary column (753) is rotationally driven in the forward direction or in the reverse direction.

A plurality of the “cross”-shaped rotors (755) are formed in a “cross” shape so that each has four rounded end portions, are separated at a regular interval along the rotary column (753), are installed by axial coupling. The “cross”-shaped rotor (755) supports each end of the horizontal movement frame (756) while rotating together as the rotary column (753) rotates.

The horizontal movement frame (756) is inserted into and penetrates the injection unit body (751) in the horizontal direction so that four horizontal movement frames (756) are perpendicular to each other on the same plane, and are seated in close contact on the “cross”-shaped rotor (755) in the hollow groove (752). As the “cross”-shaped rotor (755) rotates, the four horizontal movement frames (756) are simultaneously moved away from the rotary column (753) or horizontally moved in a direction closer to the rotary column (753) by the “cross”-shaped rotor (755).

That is, the horizontal movement frame (756) may be moved away from the rotary column (753) as the horizontal movement frame (756) comes into close contact with each branch end portion of the “cross”-shaped rotor (755), and may be horizontally moved in the direction closer to the rotary column (753) the rotary column (753) as the horizontal movement frame (756) comes into close contact with corners between branches of the “cross”-shaped rotor (755).

The curved cover (757) is formed by rounding and bending a flat plate, is supported by the cover support spring (758), is installed in each front end of the plurality of the horizontal movement frames (756) to cover the injection unit body (751), and forms a screw thread to be interlocked with a screw thread of the inward facing surface of the rotation guide groove (740) along the outward facing surface.

That is, the curved cover (757) may be moved away from the rotary column (753), and may be interlocked with the screw thread of the inward facing surface of the rotation guide groove (740) as the horizontal movement frame (756) comes into close contact with each branch end portion of the “cross”-shaped rotor (755). The curved cover (757) may be horizontally moved in the direction closer to the rotary column (753), and may be separated from the screw thread of the inward facing surface of the rotation guide groove (740) along the outward face as the horizontal movement frame (756) comes into contact with the corners between the branches of the “cross”-shaped rotor (755).

The cover support spring (758) is installed between the curved cover (757) and the injection unit body (751), and pulls the curved cover (757) in a direction of the injection unit body (751).

The rotary injection unit (750) having the above-described configuration may further include the first magnetic body (M1), the second magnetic body (M2), and the magnetic switch (759).

The first magnetic body (M1) is installed on the inner side of the curved cover (757), and a magnetism of an “N” pole or an “S” pole is formed by the magnetic switch (759).

The second magnetic body (M2) is formed in a circular ring shape along the inner side of the rotation guide groove (740) facing the first magnetic body (M1), and the magnetism of the “N” pole or the “S” pole is formed by the magnetic switch (759).

The magnetic switch (759) performs switching control on the magnetisms of the first magnetic body (M1) and the second magnetic body (M2) to the “N” pole or the “S” pole, and induces the curved cover (757) to be fastened to the inner side of the rotation guide groove (740) or the curved cover (757) to be separated from the inner side of the rotation guide groove (740).

The rotary injection unit (750) having the above-described configuration may effectively and precisely achieve close contact with or separation from the inward facing surface of the rotation guide groove (740).

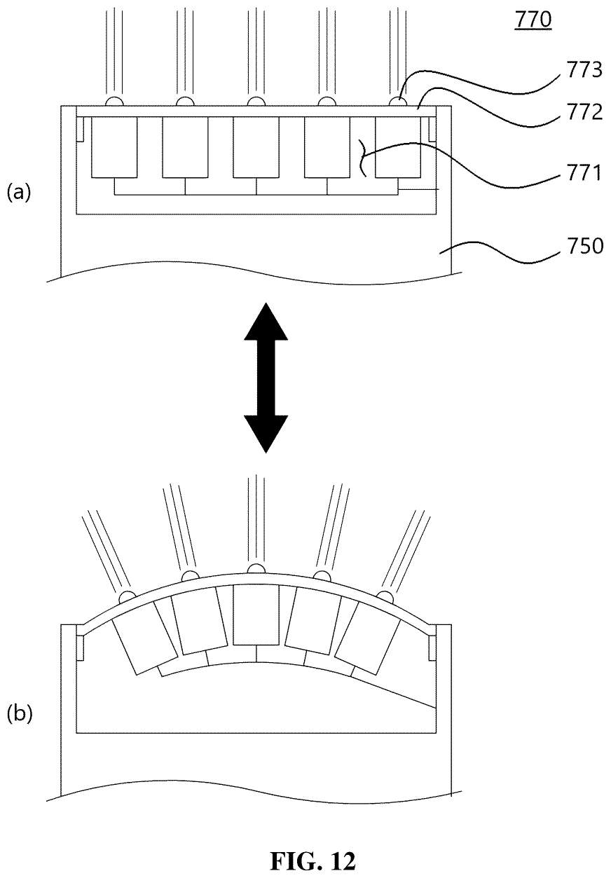

FIG. 12 is a diagram showing the injection nozzle in FIG. 9.

Referring to FIG. 12, the injection nozzle (770) includes a nozzle installation groove (771), an elastic cover (772), and a plurality of nozzles (773).

The nozzle installation home (771) is formed to be recessed into the front end of the rotary injection unit (750).

The elastic cover (772) is formed of an elastic material that can expand or contract, and is installed to cover an opening portion of the front end of the nozzle installation groove (771). As a fluid such as water and oil is supplied to the nozzle installation groove (771), the elastic cover (772) expands into a hemispherical shape due to a hydraulic pressure, and returns to a flat shape as the fluid is discharged from the nozzle installation groove (771).

The plurality of nozzles (773) are radially installed along the elastic cover (772) to inject the compressed air. When the elastic cover (772) is flat, the compressed air is injected in a direction perpendicular to the elastic cover (772), and an injection direction of the compressed air is variable as the elastic cover (772) expands.

The injection nozzle (770) having the above-described configuration may improve efficiency of removing foreign substances by variably and precisely changing an injection area of the compressed air injected through the nozzle (773) in various ways as the elastic cover (772) contracts as shown in (a) of FIG. 12 or expands as shown in (b) of FIG. 12.

The above-described embodiments are provided as examples, and those skilled in the art may understand that the above-described embodiments can be easily modified into other specific forms without changing the technical idea or the essential features of the above-described embodiments. Therefore, the above-described embodiments should be understood as illustrative and not restrictive in all respects. For example, respective component described as a single entity may be implemented in a distributed manner, and likewise, components described in the distributed manner may be implemented in a combined manner.

The scope to be protected by the present specification is indicated by the appended claims rather than the detailed description above, and should be interpreted to include all changes or modifications derived from the meaning and the scope of the appended claims and the equivalent concepts.

### REFERENCE SIGNS LIST

10, 20: Seat driven pressure inspection system
100: Main frame
200: Rail frame
300: Sensing unit
400: Qualified product reading unit

1. A seat driven pressure inspection system comprising:
a main frame installed on one side of an automobile production line for movement of a seat tray for installing a vehicle seat in which a first seat and a second seat are installed in close contact;
a rail frame installed in a horizontal direction while facing the automobile production line in an upper end of the main frame;
two sensing units installed to be slidably interlocked with the rail frame, moving rearward along the rail frame to approach the main frame when the vehicle seat moves, moving forward along the rail frame to face a measurement position of the vehicle seat when a driven pressure of the vehicle seat is measured, and sensing the driven pressure when the first seat and the second seat are folded or unfolded; and
a qualified product reading unit that reads whether the vehicle seat is qualified by using sensing information transmitted from the sensing unit.

2. The seat driven pressure inspection system of claim 1, wherein the rail frame includes a horizontal frame installed to be perpendicular to a movement direction of the vehicle seat while facing the automobile production line in the upper end of the main frame, two sliding holes formed to extend in a longitudinal direction along the horizontal frame so that an upper end of the sensing unit is mounted and moved, two servo motors installed on an upper front side of the horizontal frame, and two ball screws installed by axial coupling to a drive shaft of the servo motor, disposed along an upper side of the sliding hole, installed to be interlocked with an upper end of the sensing unit by bolt coupling, and rotationally driven in a forward direction or in a reverse direction by the servo motor to move the sensing unit forward or rearward along the sliding hole.

3. The seat driven pressure inspection system of claim 2, wherein the sensing unit includes a horizontal slider disposed in the sliding hole, installed to be interlocked with the ball screw by bolt-nut coupling, and moving along the sliding hole as the ball screw is rotationally driven in the forward direction or in the reverse direction, a vertical body installed on a lower side of the horizontal slider, a mounting portion disposed in a front end of the vertical body, a driving unit that connects the vertical body and the mounting portion to each other, and a sensor unit installed in the mounting portion and sensing the driven pressure when the first seat and the second seat are folded or unfolded.

4. The seat driven pressure inspection system of claim 3, wherein the driving unit includes a raising and lowering cylinder installed in a front end of the vertical body and moving the mounting portion to be raised or lowered in an upward-downward direction while being driven to expand or contract in an up-down vertical direction, and a rotary cylinder that rotationally drives the mounting portion.

5. The seat driven pressure inspection system of claim 4, wherein the rotary cylinder perpendicularly disposes the sensor unit to face downward so that the sensor unit senses the driven pressure in an unfolded state when the first seat and the second seat in a folded state are unfolded.

6. The seat driven pressure inspection system of claim 5, wherein the rotary cylinder horizontally disposes the sensor unit to face forward so that the sensor unit senses the driven pressure in the folded state when the first seat and the second seat in the unfolded state are folded.

7. The seat driven pressure inspection system of claim 4, wherein the sensor unit includes a mounting plate installed to be connected to the mounting portion, rotated by the rotary cylinder, and perpendicularly or horizontally disposed, a sensing block installed to be slidably interlocked with a front end of the mounting plate, and receiving a pressure when the first seat and the second seat are folded or unfolded while an end exposed from the mounting plate is in close contact with the first seat and the second seat in a folded state or in a unfolded state, and a load cell installed in a rear end of the sensing block and transmitting measured sensing information to the qualified product reading unit after measuring intensity of the pressure transmitted to the sensing block.

8. The seat driven pressure inspection system of claim 7, wherein the raising and lowering cylinder is driven to expand or contract in response to a sensing position with which the sensing block is in close contact when the first seat and the second seat are folded or unfolded, and raises or lowers the sensing block.

9. The seat driven pressure inspection system of claim 7, wherein the mounting plate includes a guide rails along one side and the other side of a front end on which the sensing block is mounted.

10. The seat driven pressure inspection system of claim 3, wherein the horizontal slider includes a connecting nut installed to be interlocked with the ball screw by bolt-nut coupling and moving along the ball screw as the ball screw is rotationally driven in the forward direction or in the reverse direction, and a nut support installed in an upper end of the vertical body, mounted on the connecting nut, and moving along the sliding hole as the connecting nut moves.
